(19) United States
(12) Patent Application Publication
(10) Pub. No.: US 2010/0101391 A1
(43) Pub. Date: Apr. 29, 2010

(54) QUICK-RELEASE MECHANISM FOR SAW MACHINE

(75) Inventor: Cheng-Hung CHIU, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/604,608

(22) Filed: Oct. 23, 2009

(30) Foreign Application Priority Data
Oct. 27, 2008 (TW) 097141179

(51) Int. Cl. B27G 19/08

(52) U.S. Cl. 83/102.1; 83/701

(57) ABSTRACT

A quick-release mechanism for use in a saw machine includes a mounting member, which has a locating hole and a positioning notch, and a connection member, which has a base attachable to one side of the mounting member. The connection member also includes a retaining block that is movable into and out of the locating hole when set in a first position and secured to the locating hole when moved with the base to a second position. The connection member further includes a positioning block that is maintained spaced from the positioning notch when the retaining block is in the first position, or that engages the positioning notch when the retaining block is moved with the base to the second position.

### FIELD OF THE INVENTION

The present invention relates to wood processing machinery and more particularly, to a quick-release mechanism for use in a saw machine.

### BACKGROUND

A saw machine generally has many safety devices to ensure operation safety. For example, a riving knife fixedly provided at the machine table behind the saw blade separates two cut pieces of wood, so as to eliminate kickback. Two check pawls may be respectively pivotally provided at two sides of the riving knife and configured to engage the workpiece to prohibit kickback of the cut pieces. A guard may be pivotally provided at the top side of the riving knife and extending over the top side of the saw blade to shield the top side of the saw blade.

In order to meet international safety codes, the installation and maintenance of the component parts of a saw machine are relatively complicated. To facilitate installation and maintenance, saw machine safety devices are commonly made detachable. In consequence, different quick-release mechanisms are extensively used with safety devices in saw machines.

According to the quick-release mechanisms of certain commercial saw machines, such as those described in TW M328333, TW I269680 (equivalent to U.S. Pat. No. 7,302,878), TW200823029 (equivalent to U.S. publication no. 2008/0121080) and TW M288213 (equivalent to U.S. Pat. No. 7,210,386), a lock pin is commonly used for single-point locking control. Further, according to the design shown in FIG. 1 (TW M288213), the quick-release mechanism comprises a locating hole 101 formed in a notch located on the top side of the riving knife 1. The notch has an open end and a closed end and an inner diameter of the closed end is greater than the size of the opening at the open end. A connection member 2 is located on the riving knife 1 for the pivotal connection of check pawls or a guard thereto. A pin 201 inserted through the connection member 2 has a neck 203, and a spring member 202 arranged concentrically on the pin 201 to impart a pressure to the pin 201 in order to hold the pin 201 in such a position where the neck 203 is maintained spaced from the locating hole 101 such that the pin 201 is retained in the locating hole 101 and the connection member 2 is maintained in position on the riving knife 1. This configuration of the single-point locking design of a quick-release mechanism is less stable. Further, the whole structure of the quick-release mechanism is complicated.

There are other known designs that eliminate the use of a spring means. For example, U.S. publication no. 2008/0022826 shows a spring free design, however the design is of a single-point locking type. Further, U.S. publication no. 2008/0047409 discloses a double-point locking design. According to this design, as shown in FIG. 2, the quick-release mechanism comprises two L-shaped locating holes 301 located on the top side of a riving knife 3. A connection member 4 is pivotally connected to a guard (not shown), and two blocks 5 are fixedly provided at the bottom side of the connection member 4 for attaching to the top side of the riving knife 3. Two pins 501 are respectively mounted in the blocks 5 for being received in the L-shaped locating holes 301. A knob 6 is mounted on the connection member 4 and is rotatable to tighten the connection member 4 to the riving knife 3. According to this design, a large amount of time is required to install and uninstall the quick-release mechanism.

### SUMMARY

The present disclosure has been accomplished under the circumstances in view. Thus, embodiments of the present disclosure provide a quick-release mechanism for a saw machine, which allows quick mounting and dismounting, and assures a high level of locking safety.

To achieve this and other objects, a quick-release mechanism for use in a saw machine comprises a mounting member and a connection member. The mounting member has a first surface, a second surface opposite to the first surface, a top side joining one side of the first surface and one side of the second surface and extending in a first direction, a locating hole extending through the first and second surfaces in a second direction perpendicular to the first direction and disposed adjacent to the top side, and a non-circular positioning notch curved inwards from the top side. The connection member is selectively connectable to the mounting member, and has a base attachable to the first surface of the mounting member, a retaining block extended from the base and insertable into the locating hole, a positioning block extended from the base and movable with the base into and out of the positioning notch, and a finger strip extended from one end of the base for moving the connection member between a first position and a second position. The retaining block has a retaining head configured correspondingly to the configuration of the locating hole. The positioning block has a friction head. When the retaining block and the positioning block are in the first position, the retaining head and the friction head are movable into and out of the locating hole and the positioning notch respectively. When the retaining block and the positioning block are in the second position, the retaining head is offset from and engaged with the locating hole, and the friction head is engaged with the positioning notch.

By means of manipulating the finger strip of the connection member to move the retaining block and the positioning block between the first position and the second position, the connection member is locked or unlocked from the mounting member. Thus, this quick-release mechanism has a simple structure and is easy to operate.

### BRIEF DESCRIPTION OF THE DRAWINGS

Other advantages and features of the present invention will be understood by reference to the following specification in conjunction with the accompanying drawings, in which like reference characters denote like elements of structure.

FIG. 1 is a schematic installed view of a quick-release mechanism according to the prior art.

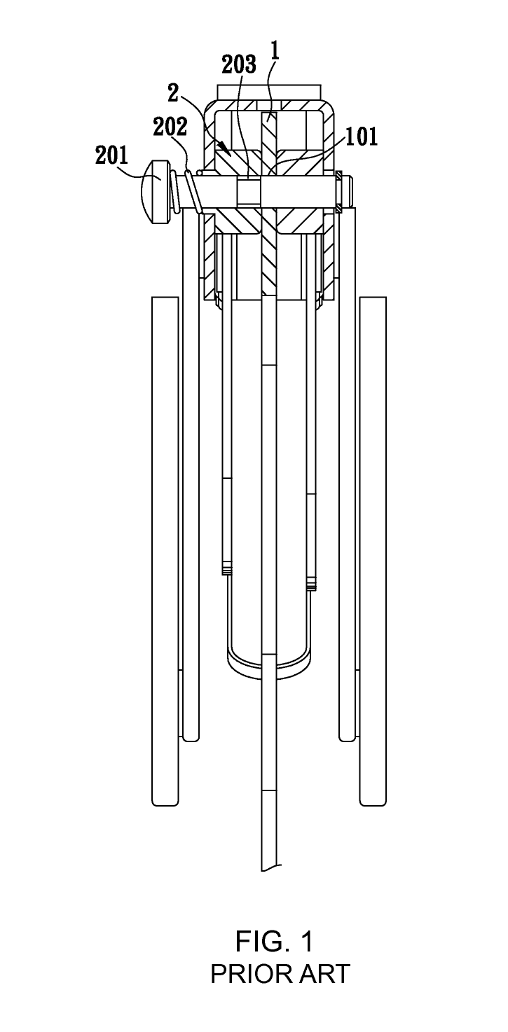

FIG. 2 is a schematic installed view of another structure of a quick-release mechanism according to the prior art.

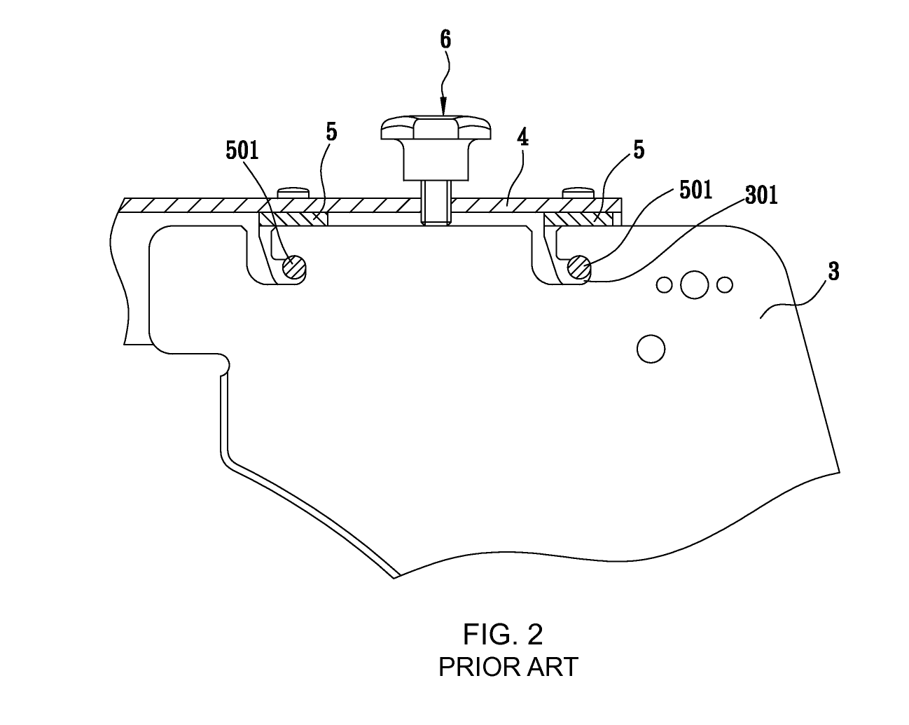

FIG. 3 is an exploded view of a quick-release mechanism in accordance with the present disclosure.

FIG. 4 is an installed view of the quick-release mechanism in accordance with the present disclosure.

FIG. 5 is a schematic front view of the present disclosure, showing the retaining block inserted into the locating hole and the positioning block maintained spaced from the positioning notch.

FIG. 6 corresponds to FIG. 5, showing the positioning block moved into the positioning hole and engaged with the second surface of the mounting member.

FIG. 7 is a sectional view taken along line VII-VII of FIG. 6.

FIG. 8 is a schematic drawing of the present disclosure, showing the quick-release mechanism of the present invention used with a saw blade guard.

### DETAILED DESCRIPTION

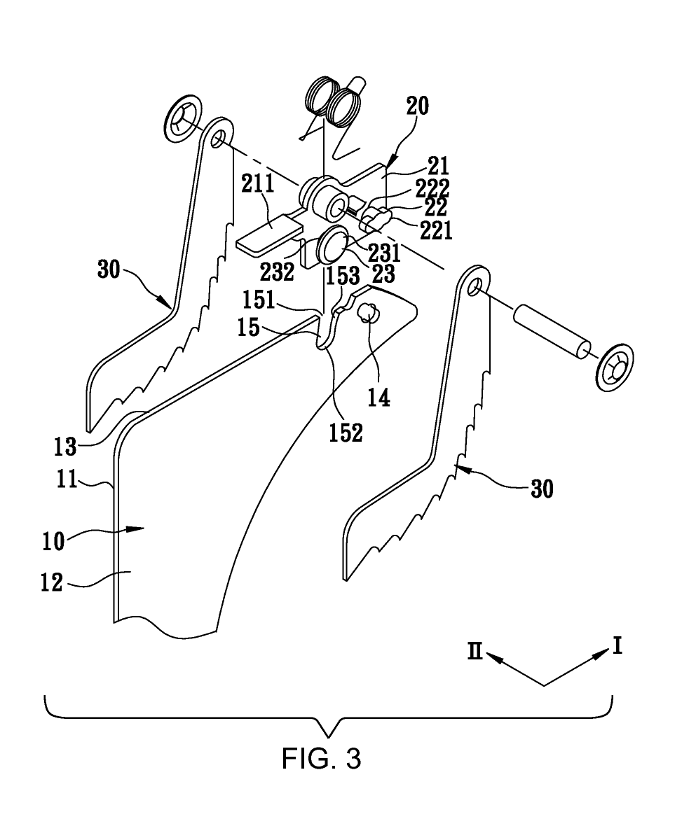

Referring to FIG. 3, a quick-release mechanism for use in a saw machine in accordance with the present disclosure is shown comprising a mounting member 10 and a connection member 20 selectively connectable to the mounting member 10. According to this embodiment, the mounting member 10 is a riving knife. The connection member 20 is adapted for the pivotal connection of two check pawls 30 at two sides relative to the mounting member 10.

The mounting member 10 is a thin flat plate member having a first surface 11, and a second surface 12 opposite to the first surface 11. A top side 13 joins the topmost edge of the first surface 11 and the topmost edge of the second surface 12 and extends in a first direction I. A locating hole 14 is disposed below the elevation of the top side 13, and a positioning notch 15 is located on the top side 13. The locating hole 14 and the positioning notch 15 each extend through the first surface 11 and the second surface 12 in a second direction II perpendicular to the first direction I. The locating hole 14 is an oblong hole. The positioning notch 15 has a single open end and an arcuate profile with a center of a circle defining the arcuate profile based on the center of the locating hole 14. The positioning notch 15 has an opening 151 formed at the top side 13 of the mounting member 10, a positioning end 152 extended inwardly from the opening 151, and a sloping guide portion 153 disposed at one side of the opening 151 adjacent to the locating hole 14.

The connection member 20 is a flat plate member, having a base 21 selectively attachable to the first surface 11 of the mounting member 10. A retaining block 22 extends from one side of the base 21, namely, the front side of the base 21 corresponding to the locating hole 14. A positioning block 23 extends from the same side of the base 21, namely, the front side of the base 21 corresponding to the positioning notch 15. A finger strip 211 extends from one end of the base 21. The retaining block 22 has an oblong retaining head 221 configured corresponding to the configuration of the locating hole 14, and a neck 222 connected between the retaining head 221 and the base 21. The positioning block 23 has a disk-like friction head 231 and a neck 232 connected between the disk-like friction head 231 and the base 21. The neck 222 of the retaining block 22 and the neck 232 of the positioning block 23 are each shaped like a round rod.

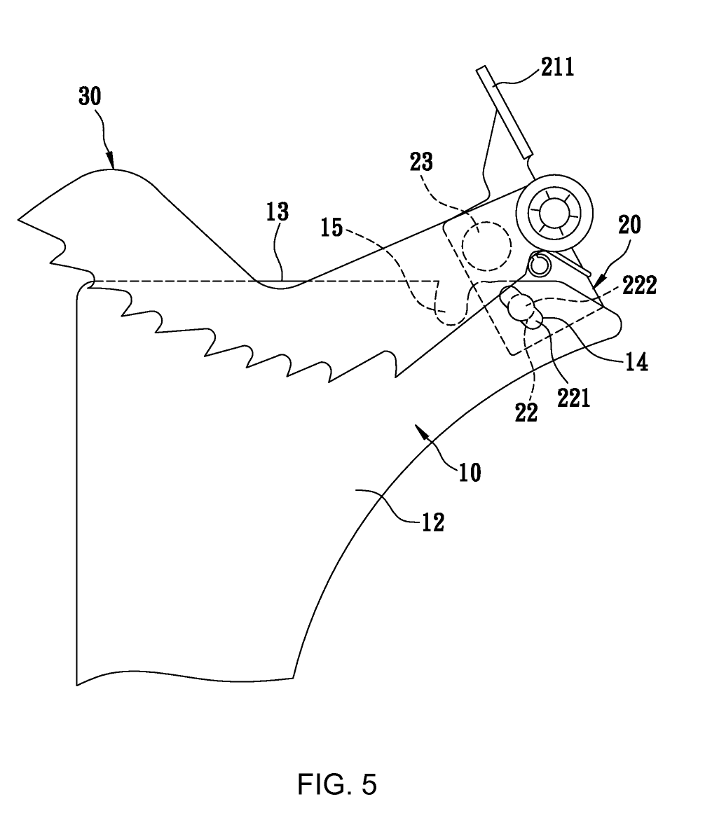

Referring to FIGS. 3 and 5, in order to connect the connection member 20 to the mounting member 10, the retaining head 221 of the retaining block 22 is set in the same orientation relative to the locating hole 14 (Thus, the retaining block 22 and the positioning block 23 are in a first position). Next, the connection member 20 is moved in the second direction II toward the mounting member 10 to insert the retaining block 22 through the locating hole 14 past the second surface 12 such that the neck 222 is supported in the locating hole 14. At this time, the positioning block 23 is suspended above the positioning notch 15, and the finger strip 211 is maintained spaced from the top side 13 of the mounting member 10.

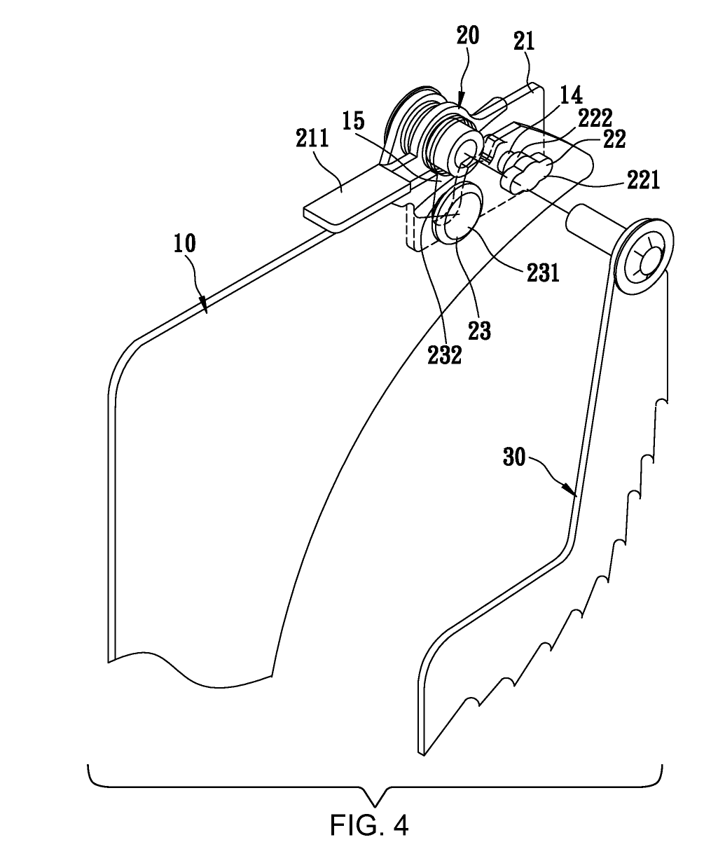

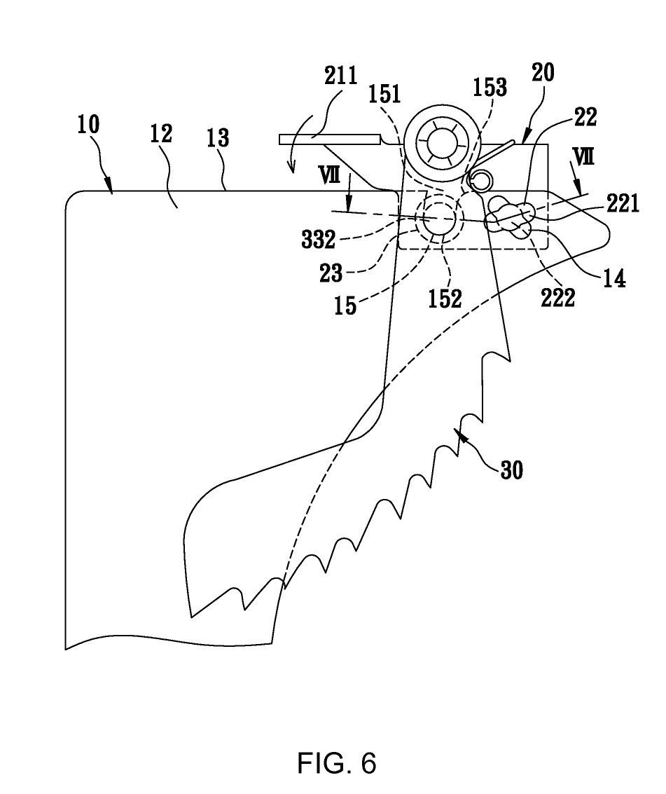

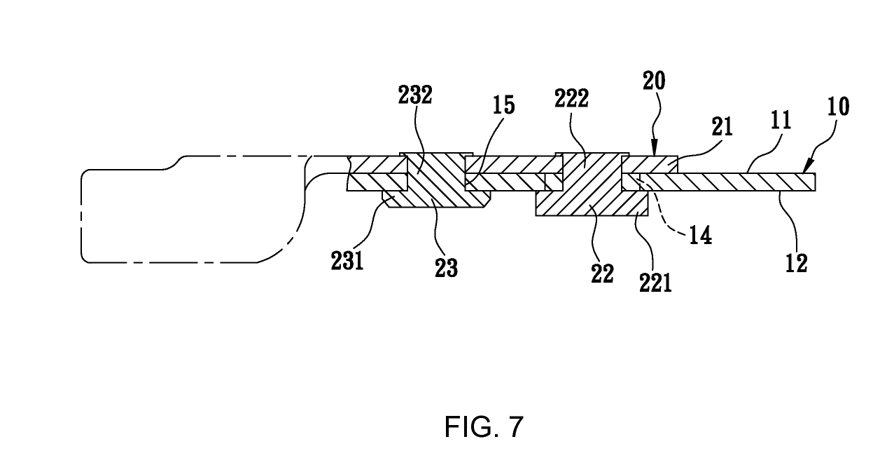

Referring to FIG. 6, next, the finger strip 211 is moved toward the top side 13 of the mounting member 10 to move the neck 232 of the positioning block 23 into the opening 151 of the positioning notch 15 and to smoothly guide the neck 232 along the sloping guide portion 153 toward the positioning end 152. At the same time, the retaining head 221 is also moved with the connection member 20 relative to the locating hole 14 so as to engage the second surface 12 of the mounting member 10, and the friction head 231 is forced into friction engagement with the second surface 12 of the mounting member 10 (thus, the retaining block 22 and the positioning block 23 are in a second position). Because the retaining head 221 and the friction head 231 each have a respective width/size greater than the diameter of the respective neck 222 or 232, the retaining head 221 and the friction head 231 are firmly engaged with the second surface 12 of the mounting member 12 (see FIG. 7). Thus, the connection member 20 is firmly positioned on the mounting member 10, and the two check pawls 30 are properly positioned relative to the mounting member 10 to achieve the expected guard effect (see FIG. 4).

In order to disconnect the connection member 20 from the mounting member 10, the finger strip 211 is moved in a direction away from the top side 13 of the mounting member 10, such that the connection member 20 is rotated about the axis extending through the neck 222 of the retaining block 22 until the retaining head 221 is returned to the same orientation relative to the locating hole 14. At the same time, the neck 232 of the positioning block 23 is moved along the border of the positioning notch 15 toward the opening 151 for enabling the retaining head 221 and the friction head 231 to be moved away from the locating hole 14 and the positioning notch 15 respectively, i.e., moved away from the second position to the first position (see FIG. 5). Thus, the operation of the quick-release mechanism of the present disclosure is quite easy.

Therefore, the quick-release mechanism of the present disclosure has the characteristics of simple structure, ease of fabrication, and ease of mounting and dismounting. By means of offset engagement between the retaining head 221 and the locating hole 14 and friction engagement between the positioning head 231 and the positioning hole 15, a two-point locating function is achieved. Further, insertion of the retaining block 22 and the positioning block 23 respectively into the locating hole 14 and the positioning notch 15, or removal of the retaining block 22 and the positioning block 23 respectively from the locating hole 14 and the positioning notch 15, is achieved simply by means of moving the connection member 20 toward the mounting member 10 and then rotating the connection member 20 relative to the mounting member 10, or rotating the connection member 20 relative to the mounting member 10 and then moving the connection member 20 away from the mounting member 10. Thus, the connection and disconnection procedure is quite simple.

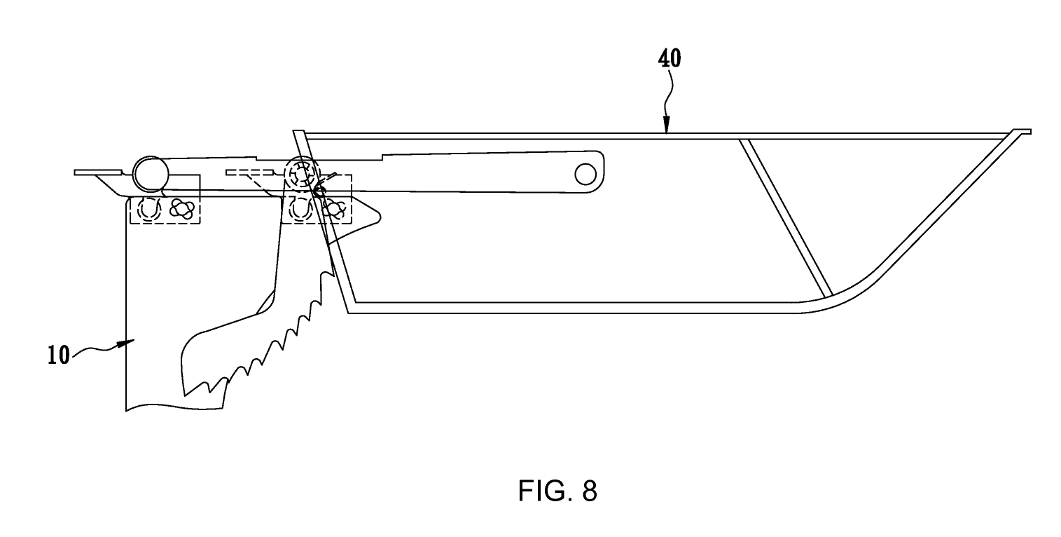

Referring to FIG. 8, the quick-release mechanism can also be used to lock a saw blade guard 40 to the mounting member 10 (riving knife).

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A quick-release mechanism for use in a saw machine, comprising:
a mounting member having a first surface, a second surface opposite to said first surface, a top side joining one side of said first surface and one side of said second surface and extending in a first direction, a locating hole extending through said first and second surfaces in a second direction perpendicular to said first direction and disposed adjacent to said top side, and a positioning notch open at the top side and curved inwardly therefrom; and
a connection member selectively connectable to said mounting member, said connection member having a base attachable to said first surface of said mounting member, a retaining block extending from said base and insertable into said locating hole, a positioning block extending from said base and movable with said base into and out of said positioning notch, and a finger strip extended from one end of said base adapted for moving said connection member between a first position and a second position, said retaining block having a retaining head configured correspondingly to the configuration of said locating hole, and said positioning block having a friction head;
wherein, in said first position, said retaining block and said positioning block are movable into and out of said locating hole and said positioning notch respectively; and when said retaining block and said positioning block are in said second position, said retaining head is offset from and engaged with said locating hole and said friction head is engaged with said positioning notch.

2. The quick-release mechanism as claimed in claim 1, wherein said retaining block has a neck connected between said retaining head and said base of said connection member; and said positioning block has a neck connected between said friction head and said base of said connection member.

3. The quick-release mechanism as claimed claim 2, wherein said locating hole is an oblong hole; said neck of said retaining block has the shape of a round rod; said retaining head of said retaining block has the shape of an oblong plate corresponding to the oblong shape of said locating hole; said friction head of said positioning block has the shape of a circular disk; and said neck of said positioning block has the shape of a round rod.

4. The quick-release mechanism as claimed in claim 3, wherein said positioning notch has a single open end formed at the top side and an arcuate profile with a center of a circle defining the arcuate profile based on the center of said locating hole, a positioning end extended inwardly from said open end, and a sloping guide portion disposed at one side of said open end adjacent to said locating hole.

5. The quick-release mechanism as claimed in claim 1, wherein said mounting member is a riving knife.
